(19) United States
(12) Patent Application Publication
(10) Pub. No.: US 2019/0019425 A1
(43) Pub. Date: Jan. 17, 2019

(54) Method for Teaching Reading with Square Pictorials

(71) Applicant: Kale Courshon, Roseville, CA (US)

(72) Inventor: Kate Courshon, Roseville, CA (US)

(21) Appl. No.: 16/030,830

(22) Filed: Jul. 9, 2018

Related U.S. Application Data
(60) Provisional application No. 62/531,361, filed on Jul. 12, 2017.

(51) Int. Cl. G09B 1/32; G09B 21/00; G09B 17/00; G09B 19/00; G09B 19/08

(52) U.S. Cl. CPC G09B 1/32; G09B 21/003; G09B 19/08; G09B 19/0092; G09B 17/00

(57) ABSTRACT

The invention teaches starving people to end starvation with a seed kit, and manual that provides a progression of dots, arrows, and a Braille canal line, and a rising sun for a user to follow first from the left side to the right side of the manual and then from the top to the bottom of each page of the manual, so that the user may learn to read first from left to right and then top to bottom. The manual also instructs a user to follow pictorial figures from left to right and from top to bottom, wherein the user learns to plant and grow the Moringa Oleifera tree and to harvest its seeds, trees and leaves as a food supply.

### CROSS-REFERENCE TO RELATED APPLICATION

This application claims the benefit of U.S. Provisional Application Ser. No. 62/531,361 filed 12 Jul. 2017, the entire contents of which is hereby incorporated herein by reference for all purposes as if fully set forth herein, under 35 U.S.C. 119(e).

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR

Not Applicable

### BACKGROUND

Unless otherwise indicated herein, the materials described in this section are not prior art to the claims in this application and are not admitted to be prior art by inclusion in this section.

### 1. Field of the Invention

The present invention relates generally to a reading instruction method for illiterate or non-English readers. More specifically, the present invention is a method, of teaching a user to read from left to right and top to bottom using arrows, dots, and Braille.

### 2. Description of Related Art

People who live in the starving zones of the world are starving, due to many factors. It is difficult for humanitarian organizations to provide a steady source of food to starving populations, because of the barriers of language and cultural differences among indigenous cultures. This makes it difficult to teach starving people the most effective steps to take to end starvation without expending significant amounts of money, time, and resources.

Accordingly, there is a need for a method to quickly and effectively bring a sustainable source of food to these starving populations, which may be quick, inexpensive, efficient, effective, and reliable. The method described in this patent application fulfills at least one of these needs or creates other utility.

### BRIEF SUMMARY OF THE INVENTION

It is a principal object to solve at least one of the disadvantages with other attempted solutions or to create other utility by providing a method that teaches starving people to end starvation that is quick, inexpensive, efficient, effective, or reliable.

The current systems that are being used today to end starvation are slow and archaic. In at least one embodiment of this invention, an instructional Manual is used to teach persons to read first from left to right, and then from top to bottom. This pattern is then followed by the user in viewing pictorial squares on a board. This instructional Manual is referred to herein as the Moringa Oleifera Seed-Kit Manual (“Manual”). The method of this invention includes using a box, which contains Moringa Oleifera seeds and the Manual, and is referred to herein as the Seed-Kit (“Seed-Kit”).

The Manual will modernize the current processes to end starvation, which are slow and archaic, with a process that is quick, inexpensive, efficient, effective, or reliable. The Manual not only teaches a method for planting and growing the Moringa Oleifera tree, but also for harvesting its seeds, bark, and leaves as a food supply. The Moringa Oleifera tree is sometimes referred to as the “miracle tree,” because of the ease of planting and growing it, and the many food and other advantages it provides.

The method of this invention may be transferred to populations of any culture or language. The method is designed to be understood and executed by any starving population that receives it, and not just the humanitarian organizations who distribute it. The method of this invention improves upon prior processes by including the Manual in a container with the Seed-Kit that may be mass manufactured and distributed anywhere in the world. The Manual uses a canal Braille system that may potentially be understood by millions of people quickly and cheaply. The Manual reduces the responsibilities of humanitarian organizations to only distributing the Seed-Kit and the Manual. The Manual is designed to be a universal, do-it-yourself system that may be used by a population of any culture or language without language confusion or issues related to translation. The Manual is designed to be mass distributed to populations who may benefit from it. The Manual allows starving people to work together collaboratively to put a plan into action for ending starvation. The Manual relieves the responsibilities for humanitarian organizations to teach indigenous peoples how to plant, grow, and cultivate the Moringa Oleifera tree. The Manual directly teaches these indigenous peoples, which frees up the time for humanitarian organizations to implement other critical tasks. The Manual is also designed to encourage indigenous people to work together in planting, growing, and harvesting the miracle tree. Once they plant the Moringa Oleifera trees, which only take about six months, to grow, the population will have begun the process of a permanent paradigm shift out of starvation.

The Manual uses a language and a culturally neutral method, so that it may be understood by many people who speak many different languages. This allows it to be understood by virtually all of the approximate 800 million people of the world, who are in severe starvation, even though they speak thousands of different languages. Currently, these many languages and cultural barriers severely hinder efforts to spread the miracle tree to starving populations.

The method of this invention is designed to revolutionize the way in which the Moringa Oleifera tree is planted, grown, and harvested. All of this information is contained within the Manual, which is distributed with seeds in the Seed-Kit. This Seed-Kit and Manual may be given to the thousands of different cultures living in the starving zones of the world. The Seed-Kit and Manual is culturally and linguistically neutral, so that it may be dropped from an airplane, if necessary, to remote regions of the world. Also, the Seed-Kit and Manual may work the same for everyone, regardless of the obscurity of their indigenous languages and cultures.

The Seed-Kit and Manual may easily be mass distributed by humanitarian organizations and world governments who already have the channels in place to distribute boxes. A one-time delivery of the Seed-Kit and Manual is all that is needed. Once the populations receive the Seed-Kit and Manual, the Manual is read and understood. The seeds from the Seed-Kit are then planted. Within about six months, the Moringa Oleifera trees grow to a point where their seeds, bark, and leaves may be used for various purposes. From that point onwards, and for generations to come, it is possible that these people may never starve, again due to the sustainable food supply that is provided by the Moringa Oleifera trees.

Thus, the Seed-Kit and Manual may revolutionize the system by which humanitarian organizations provide the basic necessities of life to end starvation to those in need. The Seed-Kit and Manual may start into motion a method to end starvation. Once starvation is ended, the population may begin to innovate and economically stabilize.

### BRIEF DESCRIPTION OF THE DRAWINGS

The accompanying drawings, which are incorporated in and constitute a part of this specification, illustrate several aspects described below.

FIG. 1 is a flowchart of the method in which at least one of the embodiments of this invention is implemented.

FIG. 2 is an instructional board with a progression of dots, arrows, and Braille used in the method in which at least one of the embodiments of this invention is implemented.

FIG. 3 is a pictorial representation of a sunrise used in the method in which at least one of the embodiments of this invention is implemented.

FIG. 4 is another pictorial representation of the distribution of the Seed-Kit in which at least one of the embodiments of this invention is implemented.

FIG. 5 is a further pictorial representation of growing and harvesting the Moringa Oleifera trees in which at least one of the embodiments of this invention is implemented.

### DETAILED DESCRIPTION OF THE INVENTION

It is to be understood that this invention is not limited to any particular embodiment described, which may vary. Also, it is to be understood that the terminology used herein is for the purpose of describing particular embodiments only, and is not intended to be limiting, since the scope of this invention will be limited only by the appended claims.

In the following detailed description, numerous specific details are set forth, in order to explain and provide a thorough understanding of the present invention. However, it is apparent that the present invention may be practiced without all of these specific details. Thus, all illustrations of the drawings are for the purpose of describing versions of the present invention, and are not intended to limit the scope of the invention.

In the following section, the present invention is described fully by referencing the details in the enclosed drawings, which illustrate certain embodiments of the invention. The numbers shown in this specification refer to the corresponding numbers in the enclosed drawings. The terminology used is to describe the particular embodiment shown and is not intended to limit the scope of the invention. The invention may also be embodied in many other forms in addition to the embodiments shown. Thus, the embodiments shown should not be construed as limiting, but rather, to allow a thorough and complete description of the disclosure that conveys the scope of the invention to a person having ordinary skill in the art in the field of this invention. Therefore, for the terms used herein, the singular forms “the,” “a,” and “an” are intended to include the plural forms as well as the singular forms, unless the context clearly indicates otherwise. The term “and” includes any and all combinations of one or more of the associated listed items. As used herein, the terms “comprising” and “comprises” when used in this specification, identify specific steps, integers, operations, features, components, and elements, but do not preclude the presence or addition of one or more other steps, operations, features, components, and elements. In addition, the features, components, and elements referenced may be exaggerated for clarity.

Unless otherwise defined, all scientific terms, technical terms, or other terms used herein have the same meaning as the term that is understood by one having ordinary skill in the art in the field of this invention. It is also understood that these terms, including their dictionary meaning, should be understood as having the meaning, which is consistent with their definitions in the related relevant art. In addition, the present disclosure is not to be interpreted in an idealized or overly formal sense unless expressly stated so herein. Constructions or functions that are well known in the art may not be fully described in detail for brevity.

In describing the invention, it is understood that a number of steps and methods may be disclosed. Each of these may have individual benefit. Also, each may be used in conjunction with at least one or more of the disclosed steps and methods. Therefore, this description will refrain from stating each and every possible combination of the individual steps and methods for the sake of brevity. Regardless, the specification and related claims should be understood with the combinations that are entirely within the scope of the claims and inventions.

The disclosure in this invention are examples of how it may be implemented and are not intended to limit the scope of the invention to the specific embodiments shown in the accompanying drawings or the description provided herein. The present invention will now be described by example in the following paragraphs by referencing the accompanying drawings, which represent embodiments and alternative embodiments.

The method of this invention teaches a method to indigenous cultures throughout the world, who currently may not know how to read any language. The method may teach these cultures to plant, grow, and harvest the Moringa Oleifera tree. This, is accomplished in part with the Manual that first teaches people how to read an instructional board, and then instructs them on how to plant, grow, and use the Moringa Oleifera trees by following the correct order on a pictorial diagram. Rather than trying to teach indigenous cultures to read an established language such as English, the Manual first teaches an order to follow in viewing pictorial diagrams for planting growing, and harvesting Moringa Oleifera trees. In this way, the Manual translates the required information into a simple universal language that may be understood by people who know anyone of the 3,000 different languages used throughout the world. The language of images, photo animation, pictures, dots, arrows, etc. are all shown on a flowchart that first reads from left to right, and then from top to bottom in a similar manner to the English language. Indigenous cultures may then “read” the animation from left to right and then from top to bottom, which is similar to how cartoons and animation are created. The pictorial instructions show small progressive adjustments from box to box that portrays a story as if the person viewing it is seeing a video.

The users must first learn how to read from left to right. The first page of the Manual teaches them how to read from left to right using a combination of dots, arrows, and Braille. The dots, arrows, and Braille guide the finger along a smooth canal line following the arrows and showing the pattern from left to right. Once the finger reaches the end of the row, the Braille canal line guides the finger down to the next line starting on the left, and again guides the finger to the end of the row and then down to the next line again and so on and so forth. Once the user's finger reaches the end of the page, the canal Braille line trails off the page, and continues on the same spot on the next page.

On the next page, the instructional Manual traces the finger back up to the top of the page starting on the first square on the first line. At this point, the user may be able to begin reading from left to right. This Braille system, continues in this manner throughout every line and every page of the Manual. Since the Manual will be mass distributed to entire populations, large groups may combine brain power collaboratively to understand the Manual and work together as a population to take action and ultimately succeed in planting and growing a Moringa Oleifera tree, and using its seeds, leaves, etc. as a food supply.

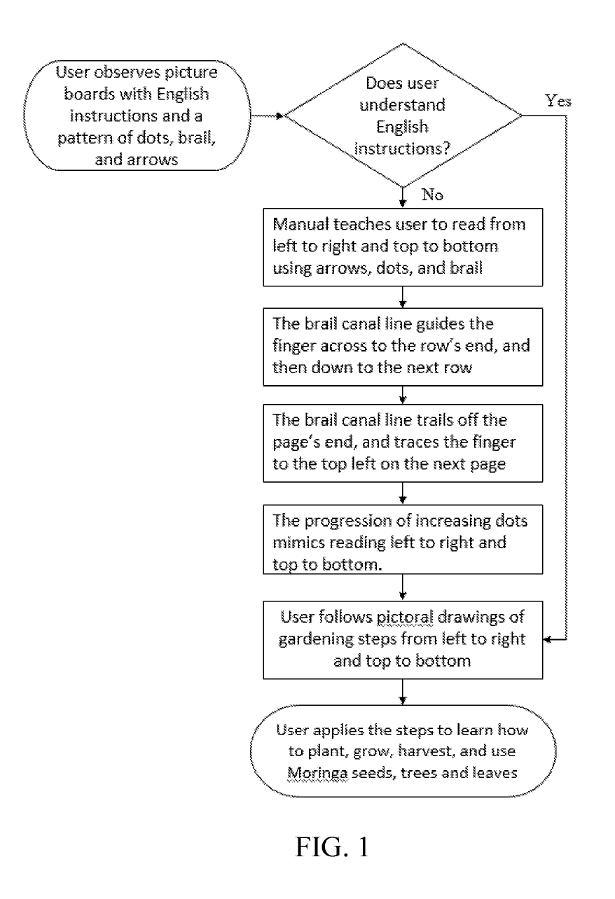

With reference to FIG. 1, a flowchart is shown demonstrating the steps a user follows in using the Manual.

First, the user observes picture boards with English instructions and a pattern of dots, brail, and arrows.

Second, it is determined if the user understands English instructions. If so, the user follows the pictorial drawings of gardening steps from left to right and top to bottom. If not, the user moves on to the third step.

Third, if the user does not understand English instructions, the Manual teaches the user to read from left, to right and top to bottom using arrows, dots, and brail through the following steps.

Fourth, if the user does not understand English instructions, the user follows the brail canal line that guides the finger across to the row's end, and then down to the next row.

Fifth, when the brail canal line trails off the page's end, it guides the finger to the top left on the next page.

Sixth, the progression of increasing dots mimics reading left to right and top to bottom.

Seventh, the user follows the pictorial drawings of gardening steps from left to right and top to bottom.

Eight, whether or not the user understands English instructions, the user applies the steps to learn how to plant, grow, harvest, and use Moringa Oleifera seeds, trees and leaves.

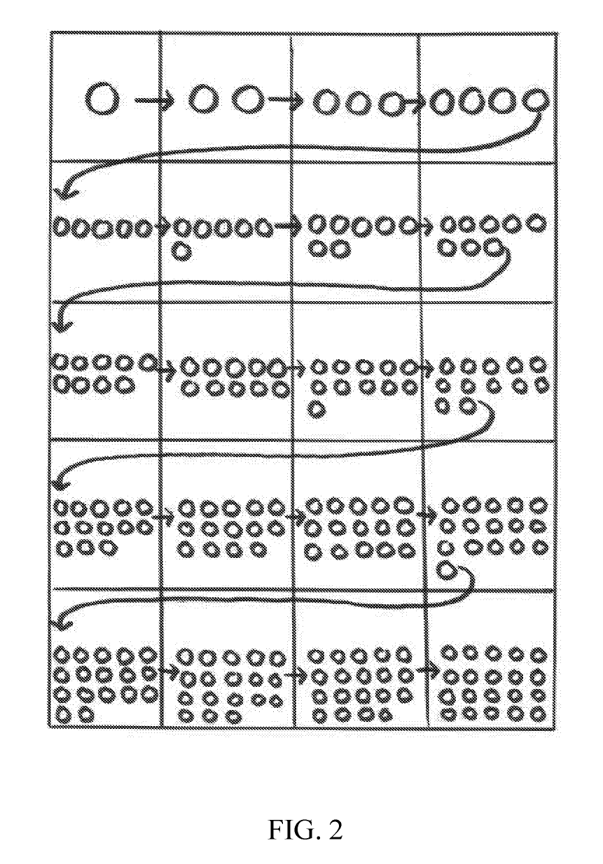

FIG. 2 shows a board that may optionally have English instructions and a pattern of dots, Braille, and arrows. In the top row of FIG. 2, the dots increase in number as the user reads from left to right. This is one of the ways that a user is taught to read from left to right. Another way is by the arrows that point from left to right and then downwards to the left side of the second row. In a similar fashion, the second row shows the dots increasing in number as the user reads from left to right and by the arrows that point from left to right and then downwards to the left side of the third row. Similarly, the third row shows the dots increasing in number from left to right and the arrows point from left to right and then downwards to the left side of the fourth row. Similarly, the fourth row shows the clots increasing in number from left to right and the arrows point from left to right and then downwards to the left side of the fifth row. The fifth row shows the dots increasing in number from left to right and the arrows point from left to right. The above described direction of progressing dots and pointed direction of the arrows teaches the user to start reading from the upper left to the right, and then from the top to the bottom.

The progression of increasing dots is similar to counting, which is often familiar to people even if they are illiterate or speak a non-English language. Also, counting is a task that most peoples are taught at a young age to assist with other tasks such as telling time, counting items in a container, playing games, etc. Many games require a person to count the number of dots or symbols on an item and translate it to a number. These include the value of a playing card, a domino, dice, etc. This recognition of the sequential order of numbers leads a person to understand the progression of dots on the instructional board. This allows a person who knows how to count to read from left to right and top to bottom. The user may then follow the same pattern in following the order on the other pictorial boards. Even illiterate persons and those of low intelligence are usually somewhat familiar with numbers and their sequential progression. Thus, this method will virtually allow all people to read the pictorial boards. Therefore, this method may be effective in teaching a great number of people to understand the steps to plant, grow, harvest, and use Moringa. Oleifera seeds, barks, and leaves.

With reference to FIG. 2, the instructional board of the Manual shows a progression of increasing dots in the same order as how English is read. The first square has one dot, the second square has 2 dots, and the third square has 3 dots, and so on through each line until the end of the page. The user's finger is guided in this simple pattern from left to right of counting, so that the user will learn the correct order to follow by counting, the increasing number of dots. This will provide the users with the foundation they will need to follow the same reading pattern for the rest of the Manual. Accordingly, this systematic and efficient method will explain how to grow and use the Moringa Oleifera tree through the progression of the square pictures.

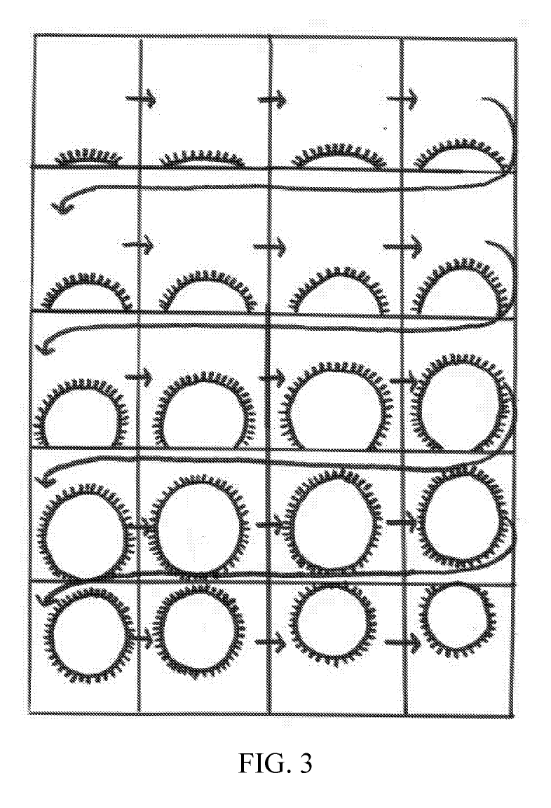

In a somewhat similar fashion to FIG. 2, FIG. 3 shows a board where a sun is shown rising from the upper left of the board to the right, and from the top of the board to the bottom.

Specifically, the top row of FIG. 3, shows the sun rising as the user reads from left to right. This is one of the ways that a user is taught to read from left to right. Another way is by the arrows that point from left to right and then downwards to the left side of the second row. In a similar fashion, the second row shows the sun continuing to rise as the user reads from left to right and by the arrows that point from left to right and then downwards to the left side of the third row. Similarly, the third row shows the sun increasing in size as it continues to rise from left to right and the arrows point from left to right and then downwards to the left side of the fourth row. Similarly, the fourth row shows the sun increasing in size as it continues to rise from left to right and the arrows point from left to right and then downwards to the left side of the fifth row. The fifth row shows the sun increasing in size as it continues to rise from left to right and the arrows point from left to right. The above described direction of the sun increasing in size as it rises, and the pointed direction of the arrows, teach the user to start reading from the upper left to the right, and then from the top to the bottom.

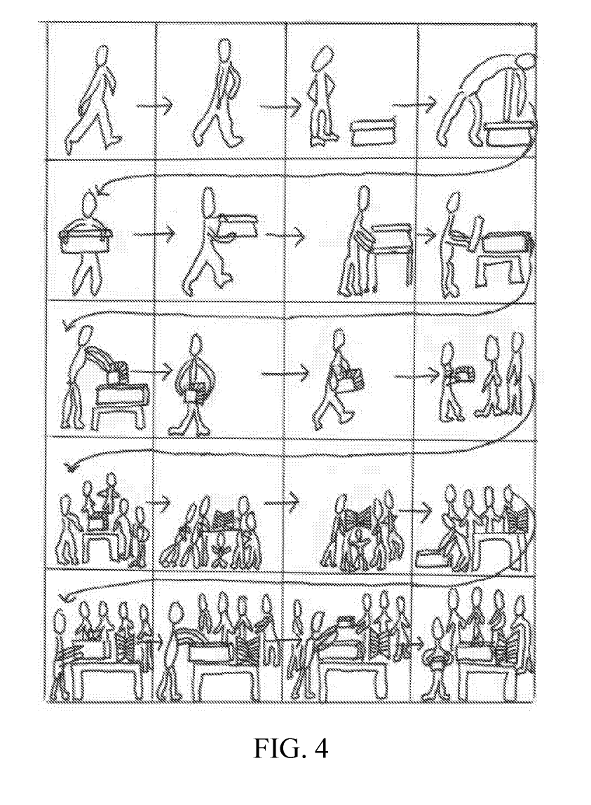

With reference to FIG. 3, the instructional board also teaches indigenous cultures to read from left to right by following pictorial figures of the rising sun. By the progression of dots and arrows in FIG. 2 and the pictorials of the rising sun of FIG. 3, the user to understand that he needs to read first from left to right and then from top to bottom. This is a two part system. The first part, as shown in FIG. 2 and FIG. 3 instructs the user to read from left to right and top to bottom. The second part, as shown in FIG. 4 teaches the user to distribute the Seed-Kit and how to plant the seeds, grow the Moringa Oleifera trees, and harvest the seeds, leave, and bark as a source of food supply.

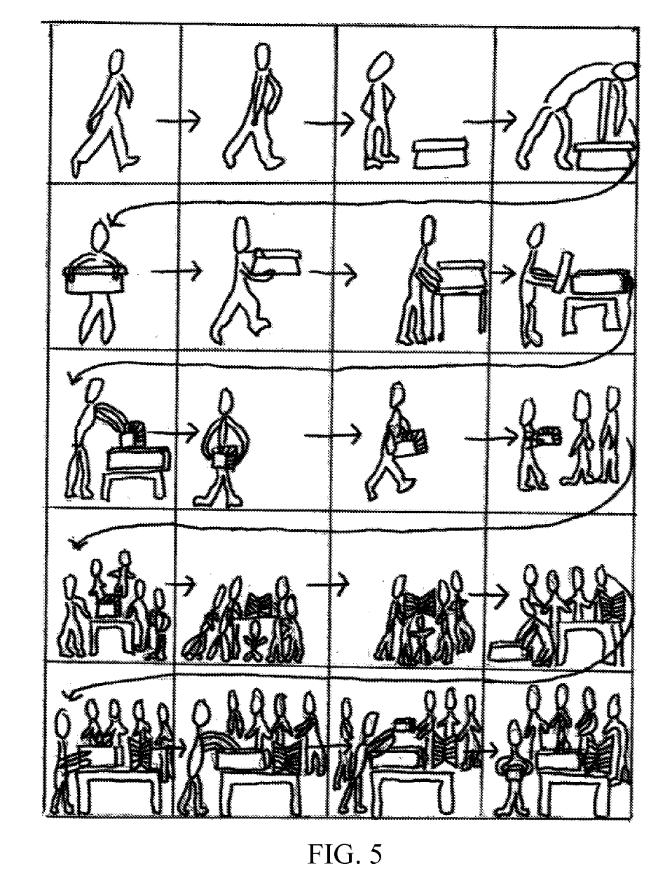

Using the method of reading from first left to right and then from top to bottom as taught in FIGS. 2 and 3, a user is able to follow the pictorial directions in FIG. 4. Specifically, the top row of FIG. 4, shows a user walking up to the seed kit, and then picking it up. The second row of FIG. 4, shows a user walking with the seed kit, placing it on a table, and then removing its cover. The third row of FIG. 4, shows a user removing the Seed-Kit contents from the box and sharing it with other people. The fourth row of FIG. 4, shows people sharing the Seed-Kit with more people. The fifth row of FIG. 5, shows more people sharing the Seed-Kit with even more people.

By also using the method of reading from first left to right and, then from top to bottom as taught in FIGS. 2 and 3, a user is able to follow the pictorial directions in FIG. 5. Specifically, the top row of FIG. 5 shows a user digging a hole in the ground and placing a Moringa Oleifera seed in it, and then periodically watering it, which causes it to begin to grow below ground.

The second row of FIG. 5 shows the user continuing to periodically water the ground above the Moringa Oleifera seed, which causes it to continue to grow above ground.

The third row of FIG. 5 shows the user continuing to periodically water the ground above the Moringa Oleifera seed, which causes it to continue grow above ground, while developing branch and spouting leafs.

The fourth row of FIG. 5 shows the user continuing to periodically water the Moringa Oleifera tree, which causes it to continue grow above ground, while developing more branches and spouting more leafs.

The fifth row of FIG. 5 shows the user watching the Moringa Oleifera tree grow larger, which causes it to continue to develop more branches and leafs.

If the user understands English, he is able to read the optional English instructions to inform him to follow the pictorial drawings on FIGS. 4 and 5, which demonstrate the steps to unpack the seed kit, and plant and grow the Moringa Oleifera seeds, trees and leaves. Otherwise, the user may understand the pictorial drawings on FIGS. 4 and 5 by following the board in FIG. 2, which shows the progression of dots, Braille, and arrows on the board. This is because as the number of dots increase from left to right, it leads the reader to learn to read from left to right. Also, as the number of dots increase from the top to the bottom, the reader is taught to read from top to bottom. In this way, a pattern emerges that leads the reader first from the left side of the board to the right side of the board and then from the top of the board to the bottom of the board. The user may learn to read from left to right by moving his finger along the Braille canal line, which will guide his finger from the left to the right until he reaches the end of the row. At this point, his finger is lead from an upper row to a lower row. In this manner, the user is taught to read from left to right and top to bottom using the arrows, dots, and Braille. Similarly, the user may learn to read from first left to right, and then from top to bottom by following the depictions of the rising sun on the board in FIG. 3.

It is not assumed that everyone who views the pictorial boards will immediately know that they should read them first from left to right, and then from top to bottom. For example, traditional Chinese text was written in vertical columns that was read first from top to bottom, and then right to left. In addition, hieroglyphs were also written in vertical columns that were sometimes read from left to right and sometimes read from right to left. To determine the proper reading order for hieroglyphs, it was necessary to observe whether the human or animal figure at the end of the row was facing left or right, since these figures always faced towards the, beginning of the line. Thus, it cannot be assumed that a person will know the order to follow the figures on the pictorial board. Therefore, in order to properly understand and follow the pictorial boards, it's important that the user first understands that they are to follow the figures from left to right and then from top to bottom.

There are many ways that the Manual may illustrate steps through square progression boards in addition to the steps of opening and sharing the seed kit, and planting and growing the Moringa Oleifera trees. For example, FIG. 5 ends with the Moringa Oleifera tree being fully grown. An additional square progression board may be created to illustrate methods of using the seeds, leafs, and bark from the Moringa Oleifera trees as a food supply. A further square progression board may be created to illustrate other steps, such as how to pound the leaves into powder and add to food, how to use this powder to purify water, how to stock pile leaf powder and Moringa Oleifera seeds for drought season, how to expel the oil from the seed, how to store the oil, how to use the oil for first aid purposes, how to use the oil for mosquito repellant, how to use the leaf powder and oil to make soap, and so on and so forth. In this manner, by the time the user reaches the end of the Manual, he will understand the following things about the Moringa Oleifera tree: (1) how to use the Manual, (2) how to plant the Moringa Oleifera seeds, (3) the process by which the tree will grow taller, (4) what to do when the tree starts producing leaves, (5) how to eat the leaves, (6) how to pound the leaves into powder and add, to food, (7) how to share this powder food with everyone in the community, (8) how the tree will begin producing flowers and pods, (9) how to eat the pods when they are young, (10) how to let the pods age, (11) how to turn the seeds into powder from the aged pods, (12) how to use this powder to purify water, (13) how to stock pile leaf powder and Moringa Oleifera seeds for drought season, (14) how to expel the oil from the seed, (15) how to store the oil, (16) how to use the oil for first aid purposes, (17) how to use the oil for mosquito repellant, (18) how to use the leaf powder and oil to make soap, (19) how to care for animals using Moringa Oleifera, (20) how to increase garden yields using the Moringa Oleifera tree, (21) how to reach out to surrounding communities with the education about the Moringa Oleifera tree and seed gifts, (22) how to teach everyone they can about it, (23) how to spread it as far as they can, and (24) how to teach other people to spread it as far as they can and so on and so forth.

In receiving the canal Braille Manual and putting it into action, the recipients will receive the following benefits within a year of receiving the miracle Seed-Kits with the Manual inside: (1) they will have a system to purify water, (2) they will have a complete protein and calcium source, (3) they will have virtually every nutrient needed by the human body in correct ratios, (4) they will have a powerful medicine source, (5) they will have diarrhea management, (6) they will have a practical system to survive drought season, (7) they will have a powerful natural antibiotic source, (8) women and female animals will have a marked increase in breast, milk production, (9) they will have an effective mosquito repellant, (10) they will no longer suffer from vitamin A deficiency disorder, (11) they will have an effective gut stabilizing de-wormer, (12) they will have a permanent antibacterial soap supply, (13) they will have a source of high oleic acid all-purpose oil, (14) they will have an antifungal procedure to heal fungal infections, (15) the animals will receive all the same benefits, (16) they will have Moringa Oleifera salt lick style blocks to survive drought season (17) they will obtain all the knowledge they need to grow a successful garden using Moringa Oleifera leaves and juice as a growth fertilizer and pesticide, and (18) they will receive preventive action against unhealthy condition.

The last page will have a brilliant life artistry to translate the God consciousness through images in a culturally and religiously neutral way. It will show a bright white light shining, down from the sky, to teach the people how to live in love, peace, kindness, non-judgement and forgiveness. This is so people will be paradigm shifted not only out of starvation, but will be paradigm, shifted spiritually as well, while maintaining the purity of their indigenous culture. It will not change the foundation of the culture, but simply infuse it with images of love and peace that may only enhance their culture in positive ways. Because human contact is not needed, the purity of their culture will not be tainted by outsiders.

The Manual will also have bright decorative golden colors. The purpose of the gold, is to communicate to indigenous cultures this Seed-Kit has extraordinary value and to not ignore it. The gold will be so shiny and beautiful, that people will be compelled to take action and do what it tells them to do, communicating in a non-language way the value of the Seed-Kit. The interior of the seed kit is shiny gold, and the seeds are in a golden pouch, so that the seed-kit will communicate “great value” to any person who may not understand language, and can be processed by anyone even if they are illiterate.

All of these embodiments and the invention disclosed herein are intended to be within the scope herein disclosed. These and other embodiments of the invention will become readily apparent to those skilled in the art from the detailed description of the preferred embodiments having reference to the attached figures, the embodiments not being limited to any particular, preferred embodiments disclosed. Also, the invention disclosed herein suitably may be practiced in the absence of any element which is not specifically disclosed herein.

What is claimed is:

1. A method for reading comprising:
providing a manual with at least one page displaying a multitude of square pictorials arranged in at least two rows and at least two columns;
providing at least one arrow in the top row of square pictorials pointing from the square pictorial on the left hand side of the top row to the square pictorial on the right hand side of the top row on at least one page of the manual;
providing at least one arrow pointing from the square pictorial on the right hand side of the top row to the square pictorial on the left hand side of the next row on at least one page of the manual;
providing at least, one arrow from the square pictorial on the left hand side of each row to the right hand side of each row until the last row is reached;
providing at least one arrow pointing from the square pictorial on the right hand side of each row to the square pictorial on the left hand side of the row below until the last row is reached;
providing at least one Braille canal line groove in the top row of square pictorials leading from the square pictorial on the left hand side of the top row to the square pictorial on the right hand side of the top row on at least one page of the manual;
providing at least one Braille canal line groove leading from the square pictorial on the right hand side of the top row to the square pictorial on the left hand side of the next row on at least one page of the manual;
providing at least one Braille canal line groove from the square pictorial on the left hand side of each row to the right hand side of each row until the last row is reached;
providing at least one Braille canal line groove leading from the square pictorial on the right hand side of each row to the square pictorial on the left hand side of the row below until the last row is reached, wherein the user learns to follow the arrows and the Braille canal line groove in learning to read from first the top left to right and top to bottom.

2. The method of claim 1, wherein on at least one page, of the manual, the square pictorials each comprise a different numbers of dots, where the number of dots is the smallest in the square pictorial on the left hand side of the top row, and the number of dots in each square pictorial steadily increases from the left hand side to the right hand side of the top row, and then again in the next row from the square pictorial on the left hand side to the square pictorial on the right hand side until the last row is reached, wherein the user follows the progressing order of the number of dots to learn to read beginning in the top row from left to right and then downwards to the next row that is also read from left to right until the last row is reached, which is also read from left to right.

3. The method of claim 2, wherein on at least one page of the manual, the square pictorials each comprise a different position of the sun rising, where the top of the sun is closest to the horizon in the square pictorial on the left hand side of the top row, and the size of the sun in each square pictorial steadily increases from the left hand side to the right hand side of the top row, and then again in the next row from the square pictorial on the left hand side to the square pictorial on the right hand side until the last row is reached, wherein the user follows the progressing order of the sun rising to learn to read beginning in the top row from left to right and then downwards to the next row that is also read from left to right until the last row is reached, which is also read from left to right.

4. The method of claim 3, wherein English instructions on at least one page of the manual, describe the order in which the square pictorials should be followed.

5. The method of claim 3, wherein on at least one page of the manual, the square pictorials each comprise a different step of distributing the seed-kit, where the seed-kit is discovered and shared by others by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove, the steadily progressing number of dots, and the order of the rising sun, beginning in the top row from left to right and then downwards to the next row that is also read from left to right until the last row is reached, which is also read from left to right.

6. The method of claim 5, wherein on at least one page of the manual, the square pictorials each comprise a different step of planting and growing the Moringa Oleifera trees by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove, the steadily progressing number of dots, and the order of the rising sun, beginning in the top row from left to right and then downwards to the next row that is also read from left to right until the last row is reached, which is also read from left to right.

7. The method of claim 6, wherein English instructions on at least one page of the manual, describe the different steps of planting and growing the Moringa Oleifera trees.

8. The method of claim 6, wherein on at least one page of the manual, the square pictorials each comprise a different step of using the Moringa Oleifera seeds and leaves as a food supply by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove, the steadily progressing number of dots, and the order of the rising sun, beginning in the top row from left to right and then downwards to the next row that is also read from left to right, until the last row is reached, which is also read from left to right.

9. The method of claim 8, wherein English instructions on at least one page of the manual, describe the using the Moringa Oleifera seeds and leaves as a food supply.

10. The method of claim 8, where the square pictorials are arranged in five rows and two columns.

11. A method for growing Moringa Oleifera trees comprising:
providing a manual with at least one page displaying a multitude of square pictorials arranged in, at least two rows and at least two columns;
providing at least one arrow in the top row of square pictorials pointing from the square pictorial on the left hand side of the top row to the square pictorial, on the right hand side of the top row on at least one page of the manual;
providing at least, one arrow pointing from the square pictorial on the right hand side of the top row to the square pictorial on the left hand side of the next row on, at least one page of the manual;
providing at least one arrow from the square pictorial on the left hand side of each row to the right hand side of each row until the last row is reached;
providing at least one arrow pointing from the square pictorial on the right hand side of each row to the square pictorial on the left hand side of the row below until the last row is reached;
providing at least one Braille canal line groove in the top row of square pictorials leading from the square pictorial on the left hand side of the top row to the square pictorial on the right hand side of the top row on at least one page of the manual;
providing at least one Braille canal line groove leading from the square pictorial on the right hand side of the top row to the square pictorial on the left hand side of the next row on at least one page of the manual;
providing at least one Braille canal line groove from the square pictorial on the left hand side of each row to the right hand side of each row until the last, row is reached;
providing at least one Braille canal line groove leading from the square pictorial on the right hand side of each row to the square pictorial on the left hand side of the row below until the last row is reached, wherein the user learns to follow the arrows and the Braille canal line groove in learning to read from first the top left to right and top to bottom.

12. The method of claim 1, wherein on at least one page of the manual, the square pictorials each comprise a different numbers of dots, where the number of dots is the smallest in the square pictorial on the left hand side of the top row, and the number of dots in each square pictorial steadily increases from the left hand side to the right hand side of the top:row, and then again in the next row from the square pictorial on the left hand side to the square pictorial on the right hand side until the last row is reached, wherein the user follows the progressing order of the number of dots to learn to read beginning in the top row from left to right and then downwards to the next row that is also read from left to right until the last row is reached, which is also read from left to right.

13. The method of claim 2, wherein on at least one page of the manual, the square pictorials each comprise a different position of the sun rising, where the top of the sun is closest to the horizon in the square pictorial on the left hand side of the top row, and the size of the sun in each square pictorial steadily increases from the left hand side to the right hand side of the top row, and then again in the next row from the square pictorial on the left hand side to the square pictorial on the right hand side until the last row is reached, wherein the user follows the progressing order of the sun rising to learn to read beginning in the top row from left to right and then downwards to the next row, that is also read from left to right until the last row is reached, which is also read from left to right.

14. The method of claim 3, wherein English instructions on at least one page of the manual, describe the order in which the square pictorials should be followed.

15. The method of claim 3, wherein on at least one page of the manual, the square pictorials each comprise a different step of distributing the seed-kit, where the seed-kit is discovered and shared by others by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove, the steadily progressing, number of dots, and the order of the rising sun, beginning in the top row from left to right and then downwards to the next row that is also read from left to right until the last row is reached, which is also read from left to right.

16. The method of claim 5, wherein on at least one page of the manual, the square pictorials each comprise a different step of planting and growing the Moringa Oleifera trees by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove, the steadily progressing number of dots, and the order of the rising sun, beginning in the top row from left to right and then downwards to the next row that is also read from left to right until the last row is reached, which is also read from left to right.

17. The method of claim 6, wherein English instructions on at least one page of the manual, describe the different steps of planting and growing the Moringa Oleifera trees.

18. The method of claim 6, wherein on at least one page of the manual, the square pictorials each comprise a different step of using the Moringa Oleifera seeds and leaves as a food supply by following the square pictorials from the left hand side of the top row, and then to the right hand side of the top row, and then again in the next row from the square pictorial on the left hand side to the square pictorial on the right hand side until the last row is reached, wherein the user follows the square pictorials in the same order as the arrows, Braille canal line groove the steadily progressing number of dots, and the order of the rising sun, beginning in the top row from left to right and then downwards to the next row that is also read from left to right until the last row is reached, which is also read from left to right.

19. The method of claim 8, wherein English instructions on at least one page of the manual, describe the using the Moringa Oleifera seeds and leaves as a food supply.

20. The method of claim 8, where the square pictorials are arranged in five rows and two columns.
